(19) United States
(12) Patent Application Publication
(10) Pub. No.: US 2026/0065186 A1
(43) Pub. Date: Mar. 5, 2026

(54) OPTIMIZING RESOURCE SCHEDULING FOR TERMINALS TO MITIGATE SHRINK AND LABOR COSTS

(71) Applicant: NCR Voyix Corporation, Atlanta, GA (US)

(72) Inventors: Itamar David Laserson, Givat Shmuel (IL); Shay Marom, Kiryat Tiv'on (IL)

(21) Appl. No.: 18/821,310

(22) Filed: Aug. 30, 2024

(51) Int. Cl. G06Q 10/0631; G06V 20/40

(52) U.S. Cl. CPC G06Q 10/06315; G06Q 10/063118; G06V 20/44

(57) ABSTRACT

A system and methods for optimizing labor scheduling in retail environments by incorporating shrink factors alongside traditional considerations are provided. A machine learning model (MLM) receives traffic data, hourly labor data, overall shrink data, and proven shrink incidents as inputs. The MLM learns the labor-shrink causality across stores, connecting staffing levels to shrink impact. The MLM outputs a recommended labor scheduling plan for both assisted and self-checkout lanes, optimized for overall store margins rather than just labor costs. This approach balances labor efficiency with shrink prevention, potentially improving store profitability. In an embodiment, an application programming interface (API) is provided for consuming recommendations from the MLM as a service to integrate insights into business intelligence dashboards, providing a comprehensive solution for retail labor management.

### BACKGROUND

Existing labor planning systems for self-service terminals (SSTs) and point-of-sale (POS) terminals face significant challenges in optimizing store operations and profitability. These systems primarily focus on minimizing labor costs and managing customer traffic, often overlooking the impact of shrink events on overall store margins. As a result, retailers may achieve apparent labor cost savings by increasing the use of SSTs, but these savings can be negated by higher shrink losses associated with self-checkout lanes. Traditional models fail to account for the complex relationship between staffing levels, customer service, and shrink prevention, leading to suboptimal resource allocation and potentially reduced profitability. Furthermore, these systems lack the ability to dynamically adjust staffing recommendations based on real-time shrink data and proven shrink incidents, leaving stores vulnerable to evolving loss patterns and unable to effectively balance labor efficiency with shrink prevention strategies.

### BRIEF DESCRIPTION OF THE DRAWINGS

FIG. 1 is a diagram of a system for optimizing resource scheduling for terminals to mitigate shrink and labor costs, according to an example embodiment.

FIG. 2 is a flow diagram of a method for optimizing resource scheduling for terminals to mitigate shrink and labor costs, according to an example embodiment.

FIG. 3 is a flow diagram of another method for optimizing resource scheduling for terminals to mitigate shrink and labor costs, according to an example embodiment.

### DETAILED DESCRIPTION

As stated above, retailers face significant challenges in optimizing their labor scheduling and resource allocation, particularly when balancing the use of traditional point-of-sale (POS) terminals with self-service terminals (SSTs). Existing labor planning systems primarily focus on minimizing labor costs and managing customer traffic, often overlooking the critical factor of shrink events and their impact on overall store margins. This oversight can lead to suboptimal resource allocation and potentially reduced profitability. For instance, while increasing the use of SSTs may appear to generate labor cost savings, these savings can be negated by higher shrink losses associated with self-checkout lanes.

Embodiments of the invention described herein provide a technical solution to the aforementioned technical problem of suboptimal resource allocation associated with existing labor planning systems by introducing an enhanced labor capacity machine learning model (MLM) that incorporates shrink factors alongside traditional considerations such as customer traffic and labor costs. This MLM learns and forecasts the impact of front-of-store labor on shrink, taking into account both staffed and self-checkout lanes. By embedding this new MLM into an existing labor capacity MLM and changing the optimization target from labor hours to overall store margin, the embodiments of the invention provide a technically improved approach to labor scheduling.

The enhanced MLM according to embodiments of the invention receives data from multiple sources, including traffic data, hourly labor data, overall shrink data from inventory systems, and proven shrink incidents from loss prevention video tracking solutions. It then learns the labor-shrink causality at each specific store and across similar stores, connecting the number of staffed lanes versus self-checkout lanes to the impact on shrink. This learning process enables the MLM to provide a recommended labor scheduling plan for both assisted lanes (POS terminals) and self-checkouts (SCOs or SSTs) that is optimized for overall store margins rather than just labor costs.

The technical benefits of embodiments disclosed herein are multifaceted. By balancing labor efficiency with shrink prevention, retailers can potentially improve overall store profitability. The MLM's ability to dynamically adjust staffing recommendations based on real-time shrink data and proven shrink incidents allows stores to adapt to evolving loss patterns more effectively. Furthermore, the integration of the MLM's insights into business intelligence dashboards and the provision of application programming interfaces (APIs) for consuming recommendations as a service offer retailers a comprehensive and flexible solution for retail labor management. This holistic approach not only addresses the immediate challenges of labor scheduling but also provides a foundation for continuous improvement in store operations and profitability.

As used herein, a “transaction terminal” refers to a SCO terminal, and SST, or a POS terminal. A transaction terminal includes a variety of integrated peripheral devices such as a bioptic scanner, a horizontal scanner, a vertical scanner, a handheld scanner, a media recycler or depository, a touch display, an item weigh scale, an integrated item weigh scale and scanner, and bagging weigh scale, a personal identification number (PIN) pad, a keyboard, one or more cameras, a card reader, one or more wireless transceivers, a media dispenser, a receipt printer, a coin dispenser, a media infeed, a coin infeed, and/or other peripheral devices.

In the case of a SCO terminal or an SST, an attendant oversees transactions of customers being performed on a pool of SCO terminals. A “SCO pool size” is a total number of SCO terminals monitored by a single attendant. In the case of a POS terminal, a single cashier performs transactions on behalf of customers at a single POS terminal.

As used herein, an “operator” refers to an individual that is operating a transaction terminal. A cashier is an operator when a customer's transaction is being performed at a POS terminal. A customer is an operator when the customer is performing a self-checkout transaction at a SCO terminal.

“Resources,” as used herein, can refer to SCO terminals, POS terminals, attendants, and/or cashiers. Typically, a store manually manages its resources for purposes of maximizing profits while minimizing costs by attempting to find an optimal mix of attendants monitoring SCO terminals and cashiers working POS terminals during any given interval of time. As will be demonstrated, manual store resource management is eliminated with teachings presented herein and an optimal mix or an optimal combination of resource allocations are provided to the store through an API. “Traffic” refers to transactions and/or items scanned at the SCO terminals and POS terminals.

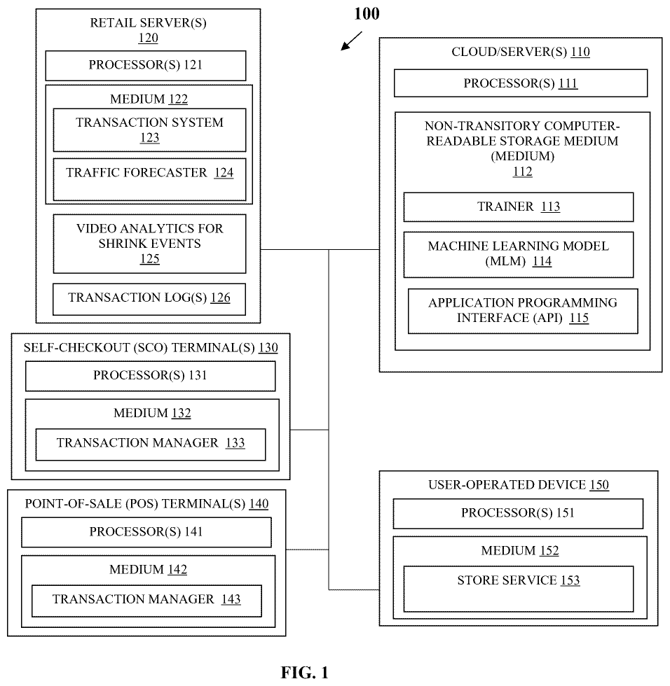

FIG. 1 is a diagram of a system 100 for optimizing resource scheduling for terminals to mitigate shrink and labor costs, according to an example embodiment. Notably, the components are shown schematically in simplified form, with only those components relevant to understanding of the embodiments being illustrated.

Furthermore, the various components (that are identified in system 100) are illustrated and the arrangement of the components are presented for purposes of illustration only. Notably, other arrangements with more or less components are possible without departing from the teachings of optimizing resource scheduling for terminals to mitigate shrink and labor costs, presented herein and below.

System 100 includes a cloud/server 110 (hereinafter “cloud 110” and may also be referred to as “cloud server 110”), one or more retail servers 120, SCO terminals 130, POS terminals 140, and one or more user-operated devices 150. Cloud 110 includes at least one processor 111 and a non-transitory computer-readable storage medium (hereinafter “medium”) 112, which includes instructions for a trainer 113, a MLM 114, and APIs 115. The instructions when executed by processor 111 cause processor 111 to perform operations discussed herein and below with respect to 113-115.

Each retail server 120 includes at least one processor 121 and a medium 122, which includes instructions for a transaction system 123 and a traffic forecaster 124. The instructions when executed by processor 121 cause processor 121 to perform operations discussed herein and below with respect to 123-124. Medium 112 also includes a variety of data stores including video analytics 125 for shrink events and transaction logs 126.

Each SCO terminal 130 includes at least one processor 131 and a medium 132, which includes instructions for a transaction manager 133. The instructions when executed by processor 131 cause processor 131 to perform processing and operations discussed herein and below with respect to 133.

Each POS terminal 140 includes at least one processor 141 and a medium 142, which includes instructions for a transaction manager 143. The instructions when executed by processor 141 cause processor 141 to perform processing and operations discussed herein and below with respect to 143.

Each user-operated device 150 includes at least one processor 151 and a medium 152, which includes instructions for a store service 153. The instructions when provided to and executed by processor 151 cause processor 151 to perform the processing or operations discussed herein and below with respect to 153.

Initially, trainer 113 obtains historical input data from multiple sources within the retail server 120 to train MLM 114. Specifically, trainer 113 retrieves transaction data from transaction system 123, which includes details of past transactions processed at both SCO terminals 130 and POS terminals 140. This transaction data provides insights into customer behavior, transaction volumes, and patterns across different terminal types. Importantly, transaction system 123 also supplies financial data, including labor costs, revenues, and profits for each store, which are essential for optimizing overall store margins.

Additionally, trainer 113 incorporates idle time between transactions by calculating transaction durations for transactions from the transaction logs 126 using transaction duration times and transaction start and tend times. This idle time accounts for activities such as bagging items, waiting for the next customer, replacing receipt rolls, and performing price checks. Including this data helps the MLM more accurately represent real-world conditions and labor requirements.

Trainer 113 may also obtain historical traffic forecast data from traffic forecaster 124. This data helps the MLM 114 understand past predictions of customer traffic, allowing it to correlate forecasted traffic with actual transaction data, shrink events, and idle times.

Trainer 113 accesses video analytics 125 for shrink events, which contains data on verified shrink incidents captured by the store's security systems. This data is essential for training the MLM 114 to recognize patterns and conditions associated with shrink events.

Trainer 113 also retrieves historical transaction logs 126, which provide a detailed record of all transactions, including timestamps, items scanned, terminal identifiers, and calculate the idle times between transactions. These transaction logs 126 offer valuable context for understanding the relationship between transaction patterns, shrink events, and labor utilization.

Trainer 113 also incorporates store-specific constraints, such as the attendant pool size for SCOs 130 and the percentage of idle time for a given interval. This information ensures that the MLM's recommendations are practical and implementable within the operational limitations of each store.

Using this comprehensive dataset, trainer 113 prepares the input for MLM 114. The trainer 113 processes and formats the data, creating features that capture the relationship between staffing levels, transaction volumes, shrink incidents, labor costs, profitability, and idle times. It also labels the data with known outcomes, such as periods of high shrink and/or optimal staffing configurations (e.g., a total number of opened SCO terminals 130 and a total number of opened POS terminals 140).

MLM 114 is then trained on this prepared dataset. The training process involves adjusting the MLM's parameters to minimize the difference between its predictions and the actual historical outcomes. The goal is for MLM 114 to learn the complex relationships between staffing levels, customer traffic, shrink events, financial performance, and idle times.

Once trained, MLM 114 can take current store data, traffic forecasts, store constraints, and expected idle times as input and output recommendations for the optimal resource mix of SCO terminals 130 and POS terminals 140 for a given interval of future time at a specific store. These recommendations aim to balance labor costs with shrink prevention, while respecting store-specific constraints and accounting for idle time, ultimately optimizing for overall store margins.

After training, MLM 114 may be deployed in a production environment to provide dynamic recommendations for optimal resource mix at regular intervals. MLM 114 receives real-time data inputs at each interval, including current transaction data from transaction system 123, updated traffic forecasts from traffic forecaster 124, and recent shrink event data from video analytics 125. It also considers the latest transaction logs 126, which include information on idle times between transactions.

Using these inputs, MLM 114 generates a recommendation for the optimal resource mix of SCO terminals 130 and POS terminals 140 for the next interval of time. This recommendation takes into account the current store conditions, predicted customer traffic, recent shrink events, labor costs, and store-specific constraints such as the attendant pool size for SCOs 130.

The recommendation from MLM 114 is then passed to API 115, which serves as an interface between the cloud server 110 and various store services 153 running on user-operated devices 150. API 115 formats the recommendation data in a standardized way, making it easily consumable by different types of store services 153.

Store services 153 can include applications for store managers, scheduling software, or business intelligence dashboards. These services can request the latest recommendation through API 115 at any time, allowing for real-time adjustments to staffing and resource allocation.

An example is now presented to illustrate the operation of system 100 within a given store environment. At 9:00 AM, transaction system 123 records a surge in customer traffic at the store's SCO terminals 130. Simultaneously, video analytics 125 detects an increase in potential shrink events associated with the high traffic at the SCO terminals 130. Traffic forecaster 124 predicts that this high traffic will continue for the next hour based on historical patterns. This real-time data is fed into MLM 114, which quickly processes the information. MLM 114 generates a new recommendation for the 10:00 AM-11:00 AM interval, suggesting an increase in the number of active SCO terminals 130 and attendants to manage the high traffic while mitigating the risk of shrink and maintaining the current opened POS terminals manned by cashiers at the store. This recommendation is passed to API 115, which formats it for consumption by store services 153.

A store manager, using a scheduling application (one of the store services 153) on their user-operated device 150, receives an alert about the updated recommendation. The store manager reviews the recommendation through their application interface and decides to implement the suggested changes, increasing the number of active SCO terminals 130 and assigning additional attendants for the 10:00 AM-11:00 AM period. As the store environment continues to change throughout the day, this process repeats at regular intervals, ensuring that staffing and resource allocation remain optimized for both customer service and shrink prevention. This real-time adjustment capability allows the store to respond quickly to changing conditions, balancing labor costs, customer service, and shrink prevention to optimize overall store margins.

MLM 114 utilizes a feedback loop to continuously learn and improve its recommendations as conditions related to shrink events evolve within a store. This adaptive learning process involves several key components;
1. Real-time data integration: The MLM 114 continuously receives updated data from various sources, including transaction system 123, video analytics 125 for shrink events, and transaction logs 126. This real-time data allows the MLM 114 to stay current with the latest trends and patterns in shrink events.
2. Performance evaluation: After each interval, the MLM 114 compares its recommendations against the actual outcomes. It analyzes factors such as the accuracy of its shrink predictions, the effectiveness of the recommended resource allocation in preventing shrink, and the impact on overall store margins.
3. Error analysis: When discrepancies are found between predicted and actual outcomes, the MLM 114 performs an in-depth analysis to identify the root causes. This may involve examining specific features or combinations of features that led to inaccurate predictions.
4. Parameter adjustment: Based on the error analysis, the MLM 114 adjusts its internal parameters to improve its predictive accuracy. This may involve fine-tuning the weights assigned to different features, such as the relationship between staffing levels and shrink incidents.
5. Incorporation of new patterns: As new shrink patterns emerge; the MLM 114 learns to recognize and account for these in its future recommendations. For example, if a new type of shrink event is identified through video analytics 125, the MLM 114 incorporates this information into its decision-making process.
6. Adaptive thresholds: The MLM 114 may adjust its thresholds for triggering certain recommendations based on the evolving shrink landscape. For instance, it might lower the threshold for recommending additional staff during certain hours if shrink events are consistently occurring during those times.
7. Store-specific learning: The MLM 114 develops store-specific insights over time, recognizing that shrink patterns may vary between different locations. This allows for more tailored and effective recommendations for each individual store.
8. Seasonal adjustments: The MLM 114 learns to anticipate and account for seasonal variations in shrink patterns, adjusting its recommendations accordingly. This might involve recognizing increased shrink risks during holiday shopping periods, for example.
9. Feedback from store managers: The system may incorporate feedback from store managers on the effectiveness of its recommendations. This human input can help refine the MLM's understanding of practical constraints and considerations that may not be fully captured in the data.

By continuously incorporating these feedback mechanisms, MLM 114 becomes increasingly adept at predicting and mitigating shrink events over time. This adaptive approach ensures that the system 100 remains effective even as shrink tactics evolve and store conditions change, providing retailers with a dynamic and responsive solution for optimizing their resource allocation while minimizing losses associated with shrink.

In an embodiment, system 100 is designed to handle various types of shrink events, including shoplifting, employee theft, and administrative errors. MLM 114 is trained on data from video analytics 125 for shrink events, which captures a wide range of shrink incidents. The MLM 114 learns to differentiate between these types of events and their associated patterns, allowing it to provide tailored recommendations for each. For instance, if employee theft is detected as a significant issue, the MLM 114 may recommend increased supervision or training for staff. For shoplifting, it might suggest optimizing the placement of high-risk items or increasing the number of attendants during peak hours. By distinguishing between different shrink types, the system 100 can offer more targeted and effective strategies for prevention.

In an embodiment, system 100 is designed to adapt to edge cases and unexpected scenarios that might affect shrink patterns. For instance, if there's a sudden change in store layout, the system 100 can quickly adjust its recommendations based on the new spatial data input. When new technology is introduced that might affect shrink patterns, such as advanced security cameras or RFID tags, the MLM 114 can be rapidly retrained to incorporate these new factors. The system's ability to continuously learn and update its parameters, ensuring that it can handle unforeseen circumstances and evolving shrink tactics. In cases of highly unusual events, the system 100 may flag these for human review, allowing store managers to provide additional context or override recommendations if necessary.

In an embodiment, and beyond the API 115, system 100 is designed to integrate seamlessly with a wide range of existing store systems. For example, it can interface with inventory management software to correlate shrink events with specific product categories or stock keeping units (SKUs). The system 100 can also integrate with employee scheduling software, allowing for automatic adjustments to staffing based on its recommendations. Furthermore, it can connect with POS systems to gather real-time transaction data, and with security systems to receive immediate alerts of potential shrink events. This comprehensive integration ensures that the system's recommendations are based on the most current and complete data available, and that these recommendations can be easily implemented across various store operations.

In an embodiment, system 100 is highly scalable, capable of being implemented across multiple stores or even different retail chains. The cloud-based architecture of cloud server 110 allows for easy expansion to handle increased data loads and computational requirements as more stores are added. The MLM 114 can be trained on data from multiple stores, learning to identify both common patterns and store-specific nuances in shrink events. This allows for both generalized and localized recommendations. The API 115 can be configured to provide recommendations at various levels-from individual store managers to regional directors overseeing multiple locations. This scalability ensures that retailers can implement the system 100 across their entire operation, gaining insights and optimizing resource allocation at both the micro and macro levels.

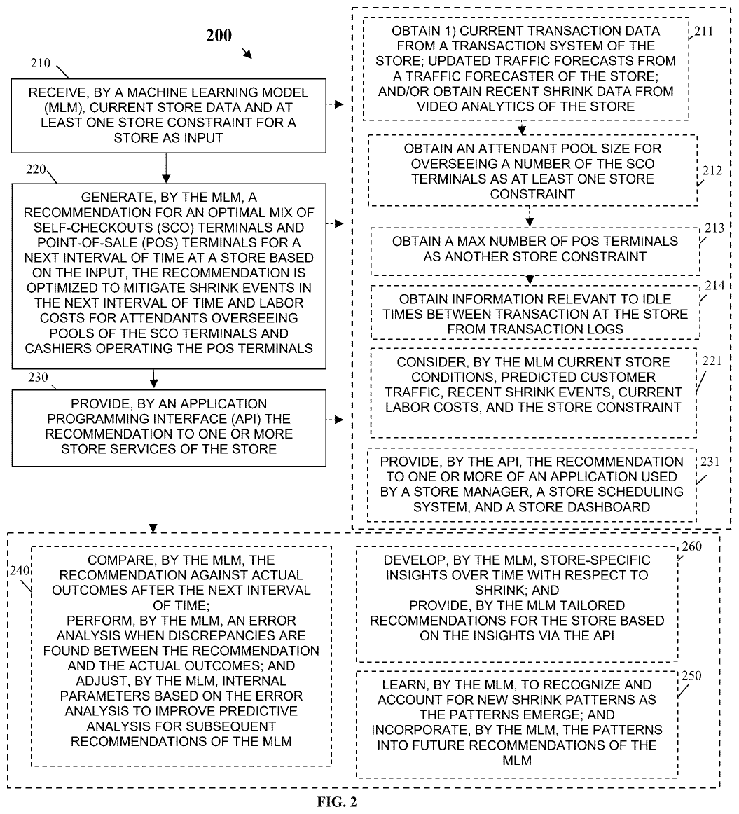

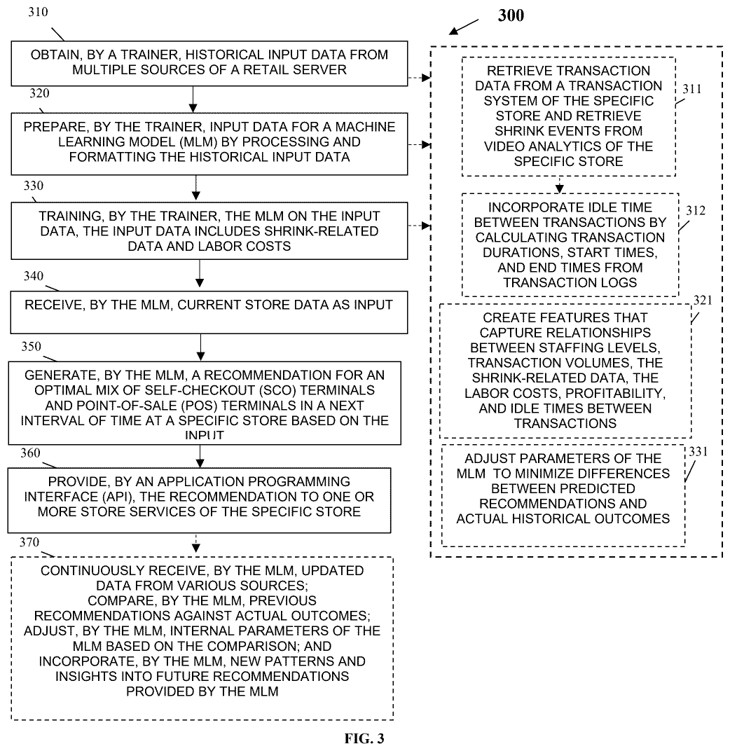

The above-referenced embodiments and other embodiments are now discussed with reference to FIGS. 2 and 3. FIG. 2 is a flow diagram of a method 200 for optimizing resource scheduling for terminals to mitigate shrink and labor costs, according to an example embodiment. The software module(s) that implements the method 200 is referred to as an “optimal shrink-sensitive SCO and POS terminal staffing predictor.” The optimal shrink-sensitive SCO and POS terminal staffing predictor is implemented as executable instructions programmed and residing within memory and/or a non-transitory computer-readable (processor-readable) storage medium and executed by one or more processors of one or more devices. The processor(s) of the device(s) that executes the optimal shrink-sensitive SCO and POS terminal staffing predictor are specifically configured and programmed to process the optimal shrink-sensitive SCO and POS terminal staffing predictor. The optimal shrink-sensitive SCO and POS terminal staffing predictor may have access to one or more network connections during its processing. The network connections can be wired, wireless, or a combination of wired and wireless.

In an embodiment, the device that executes the optimal shrink-sensitive SCO and POS terminal staffing predictor is cloud 110. In an embodiment, the device that executes the optimal shrink-sensitive SCO and POS terminal staffing predictor is a retail server 120. In an embodiment, the optimal shrink-sensitive SCO and POS terminal staffing predictor is any combination of or all of trainer 113, MLM 114, and/or API 115.

At 210, optimal shrink-sensitive SCO and POS terminal staffing predictor used a MLM 114 and MLM 114 receives current store data and at least one store constraint for a store as input. In an embodiment, at 211, the optimal shrink-sensitive SCO and POS terminal staffing predictor obtains current transaction data from a transaction system 123 of the store as a first portion of the current store data. In an embodiment of 211 and at 212, the optimal shrink-sensitive SCO and POS terminal staffing predictor obtains traffic forecasts from a traffic forecaster 124 of the store as a second portion of the current store data; obtains recent shrink data from video analytics 125 as third portion of the current store data.

In an embodiment of 212 and at 213, the optimal shrink-sensitive SCO and POS terminal staffing predictor obtains an attendant pool size for a single attendant to oversee a given number of SCO terminals as at least one store constraint. In an embodiment, of 213 and at 214, the optimal shrink-sensitive SCO and POS terminal staffing predictor obtains a maximum number of POS terminals as at least one additional store constraint. In an embodiment of 214 and at 215, the optimal shrink-sensitive SCO and POS terminal staffing predictor obtains information relevant to idle times between transaction at the store from transaction logs 126 of the store as a fourth portion of the current store data.

At 220, the MLM 114 generates a recommendation for an optimal mix of SCO terminals 130 and POS terminals 140 for a next interval of time at a store based on the input. The recommendation is optimized to mitigate shrink events in the next interval of time and labor costs for attendants overseeing pools of the SCO terminals 130 and cashiers operating the POS terminals 140. In an embodiment, at 221, the MLM 114 considers store conditions, predicted customer traffic, recent shrink events, current labor costs, and the store constraints when generating the recommendation.

At 230, the optimal shrink-sensitive SCO and POS terminal staffing predictor uses an API 115, and the API 115 provides the recommendation to one or more store services 153 of the store. In an embodiment, at 231, the API 115 provides the recommendation to one or more of an application used by a store manager of the store, a store scheduling system for the store, and a store dashboard interface integrated into an application or a system of the store.

In an embodiment, at 240, the MLM 114 compares the recommendation against actual outcomes after the next interval of time. The MLM 114 performs an error analysis when discrepancies are found between the recommendation and the actual outcomes. The MLM 114 adjusts internal parameters based on the error analysis to improve predictive analysis for subsequent recommendations of the MLM 114.

In an embodiment, at 250, the MLM 114, learns to recognize and account for new shrink patterns as the shrink patterns emerge. The MLM 114 incorporates the patterns into future recommendations of the MLM 114.

In an embodiment, at 260, the MLM 114 develops store-specific insights over time with respect to shrink at the store. The MLM 114 provides tailored additional recommendations for the store based on the insights via API 115.

FIG. 3 is a diagram of another method 300 for optimizing resource scheduling for terminals to mitigate shrink and labor costs, according to an example embodiment. The software module(s) that implements the method 300 is referred to as a “shrink-sensitive SCO and POS staffing predictor.” The shrink-sensitive SCO and POS staffing predictor is implemented as executable instructions programmed and residing within memory and/or a non-transitory computer-readable (processor-readable) storage medium and executed by one or more processors of one or more device(s). The processors that execute the shrink-sensitive SCO and POS staffing predictor are specifically configured and programmed for processing the shrink-sensitive SCO and POS staffing predictor. The shrink-sensitive SCO and POS staffing predictor may have access to one or more network connections during its processing. The network connections can be wired, wireless, or a combination of wired and wireless.

In an embodiment, the device that executes shrink-sensitive SCO and POS staffing predictor r is cloud 110. In an embodiment, the device that executes the shrink-sensitive SCO and POS staffing predictor is retail server 120. In an embodiment, the shrink-sensitive SCO and POS staffing predictor is any combination of or all of trainer 113, MLM 114, API 115, and/or method 200. The shrink-sensitive SCO and POS staffing predictor presents another and, in some ways, enhanced processing perspective from that which was discussed above for the system 100 of FIG. 1 and/or method 200 of FIG. 2.

At 310, the shrink-sensitive SCO and POS staffing predictor uses a MLM trainer 113, and the trainer 113 obtains historical input data from multiple sources of a retail server 120. In an embodiment, at 311, the trainer 113 retrieves transaction data from a transaction system 123 of a specific store. The trainer 113 also retrieves shrink events from video analytics 125 of the specific store. In an embodiment of 311 and at 312, the trainer 311 incorporates idle time between transaction by calculating transaction durations, start times, and end times from transaction logs 126 of the specific store.

At 320, the trainer 113 prepares input data for a MLM 114 by processing and formatting the historical input data. In an embodiment, at 321, the shrink-sensitive SCO and POS staffing predictor creates features that capture relationships between staffing levels, transaction volumes, shrink-related data, labor cots, profitability, and idle times between transactions.

At 330, the shrink-sensitive SCO and POS staffing predictor trains the MLM 114 on the input data, which at least includes shrink-related data and labor costs. In an embodiment, at 331, the trainer 113 adjusts parameters of the MLM 114 to minimize differences between predicted recommendations and actual historical outcomes.

At 340, the MLM 114 receives current store data as input. At 350, the MLM 114 generates a recommendation for an optimal mi of SCO terminals 130 and POS terminals 140 in a next interval of time at a specific store based on the input. At 360, the shrink-sensitive SCO and POS staffing predictor uses an API 115, and the API 115 provides the recommendation to one or more store services 153 of the specific store. This provides integration of the recommendation into relevant store services 153.

In an embodiment, at 370, the MLM 114 continuously receives updated data from various sources. The MLM 114 compares previous recommendations against actual outcomes. The MLM 114 adjusts internal parameters of the MLM 114 based on the comparison and the MLM 114 incorporates new patterns and insights into future recommendations provided by the MLM 114.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving, by a machine learning model (MLM) executing on a cloud server, current store data and at least one store constraint for a store as input;
generating, by the MLM, a recommendation for an optimal resource mix of self-checkout (SCO) terminals and point-of-sale (POS) terminals for a next interval of time at the store based on the input, wherein the recommendation is optimized to mitigate shrink events in the next interval of time and labor costs for attendants overseeing the SCO terminals and cashiers operating the POS terminals;
evaluating, by the MLM, relationships between staffing levels of the attendants and cashiers, transaction volumes at the SCO terminals and POS terminals, the shrink events captured from video analytics, idle times between transactions calculated from transaction logs, and the labor costs;
calculating, by the MLM, an expected shrink rate for different combinations of opened SCO terminals and opened POS terminals based on historical correlations between terminal configurations and shrink incidents;
selecting, by the MLM, a specific combination of a number of opened SCO terminals and a number of opened POS terminals that optimizes overall store margin by balancing the labor costs against expected losses from the shrink events; and
providing, via an application programming interface (API), the recommendation for consumption by one or more store services of the store.

2. The method of claim 1, wherein receiving further includes obtaining one or more of current transaction data from a transaction system of the store, obtaining updated traffic forecasts from a traffic forecaster of the store, or obtaining recent shrink event data from video analytics of the store.

3. The method of claim 2, wherein receiving further includes obtaining an attendant pool size for overseeing a number of SCO terminals as at least one store constraint.

4. The method of claim 3, wherein receiving further includes obtaining a maximum number of opened POS terminals as at least one additional store constraint.

5. The method of claim 4, wherein receiving further includes obtaining information relevant to idle times between transactions at the store from transaction logs of the store.

6. The method of claim 1, wherein generating further includes evaluating, by the MLM, current store conditions, predicted customer traffic, recent shrink events, current labor costs, and the at least one store constraints.

7. The method of claim 6, wherein considering further includes identifying an attendant pool size for overseeing the SCO terminals.

8. The method of claim 1, wherein providing further includes providing, via the API, the recommendation to one or more of:
an application used by a store manager, a store scheduling system, or a store dashboard.

9. The method of claim 1, further comprising:
comparing, by the MLM, the recommendation against actual outcomes after the next interval of time;
performing, by the MLM, an error analysis when discrepancies are found between the recommendation and the actual outcomes; and
adjusting, by the MLM, internal parameters based on the error analysis to improve predictive accuracy for subsequent recommendations provided by the MLM.

10. The method of claim 1, further comprising:
learning, by the MLM, to recognize and account for new shrink patterns as the new shrink patterns emerge; and
incorporating, by the MLM, the new shrink patterns into future recommendations of the MLM.

11. The method of claim 1, further comprising:
developing, by the MLM, store-specific insights over time with respect to shrink; and
providing, by the MLM, tailored recommendations for the store based on the store-specific insights via the API.

12. A method, comprising:
obtaining, by a trainer executed on a cloud server, historical input data from multiple sources of a retail server;
preparing, by the trainer, input data for a machine learning model (MLM) by processing and formatting the historical input data;
creating features that capture causal relationships between staffing configurations of self-checkout (SCO) terminal attendants and point-of-sale (POS) terminal cashiers and shrink incident rates by analyzing temporal correlations between changes in staffing levels and occurrences of shrink events recorded in video analytics;
calculating idle time metrics between transactions by determining transaction duration times from transaction start times and transaction end times recorded in transaction logs;
associating shrink incident data from the video analytics with corresponding staffing configurations and transaction volumes to establish training patterns that connect resource allocation to shrink prevention;
training, by the trainer, the MLM on the input data, wherein the prepared input data includes shrink-related data and labor costs;
receiving, by the MLM, current store data for a store as input;
generating, by the MLM, a recommendation for an optimal mix of self-checkout (SCO) terminals and point-of-sale (POS) terminals in a next interval of time at a specific store based on the input; and
providing, by an application programming interface (API), the recommendation to one or more store services of the specific store.

13. The method of claim 12, wherein obtaining further includes retrieving transaction data from a transaction system of the specific store and retrieving shrink events from video analytics of the specific store.

14. The method of claim 13, wherein obtaining further includes incorporating idle time between transaction by calculating transaction durations, start times, and end times from transaction logs of the specific store.

15. The method of claim 12, wherein preparing further includes creating features that capture relationships between staffing levels, transaction volumes, the shrink-related data, the labor costs, profitability, and idle times between transactions.

16. The method of claim 12, wherein training further includes adjusting parameters of the MLM to minimize differences between predicted recommendations and actual historical outcomes.

17. The method of claim 12, further comprising:
continuously receiving, by the MLM, updated data from various sources;
comparing, by the MLM, previous recommendations against actual outcomes;
adjusting, by the MLM, internal parameters of the MLM based on the comparing; and
incorporating, by the MLM, new patterns and insights into future recommendations provided by the MLM.

18. A system comprising:
a cloud server comprising at least one processor and a non-transitory computer-readable storage medium;
the non-transitory computer-readable storage medium comprising instructions; and
the instructions when executed by the at least one processor cause the at least one processor to perform operations comprising:
training a machine learning model (MLM) on historical input data from multiple sources to provided recommendations on an optimal mix of self-checkout (SCO) terminals and self-service terminals (SSTs) for a given store, wherein the recommendations are optimized to minimize shrink and labor costs of the given store;
learning labor-shrink causality patterns by identifying correlations between numbers of staffed lanes versus self-checkout lanes and impacts on shrink rates across multiple stores;
establishing store-specific shrink profiles by analyzing shrink incidents from video analytics in relation to concurrent staffing configurations;
adjusting parameters of the MLM to predict shrink risk levels for different resource allocation scenarios based on the learned causality patterns;
receiving current store data, traffic forecasts, store constraints, shrink events, and expected idle times between transactions of a particular store as input to the MLM;
generating, by the MLM, a current recommendation for a current optimal mix of the SCO terminals and SSTs for a next interval of time at the particular store based on the input; and
providing, by an application programming interface (API) the current recommendation to one or more store services associated with the particular store.

19. The system of claim 18, wherein the operations further comprise:
comparing the current recommendation against actual outcomes after the next interval of time;
performing an error analysis when discrepancies are found between the current recommendation and the actual outcomes; and
adjusting parameters of the MLM based on the error analysis to improve predictive accuracy of the MLM with subsequent recommendations provided by the MLM.

20. The system of claim 19, wherein the operations further comprise:
developing, by the MLM, store-specific insights over time for the particular store; and
providing, by the MLM, tailored recommendations for the particular store based on the store-specific insights.
